(19) United States
(12) Patent Application Publication
(10) Pub. No.: US 2003/0180964 A1
(43) Pub. Date: Sep. 25, 2003

(54) Method for immobilizing analyte sensitive materials on a sol-gel matrix

(76) Inventors: Dan-Hui Yang, Sunnyvale, CA (US); Ganapati R. Mauze, Sunnyvale, CA (US); David J. Anvar, Mountain View, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/101,336

(22) Filed: Mar. 20, 2002

(51) Int. Cl. G01N 21/17

(52) U.S. Cl. 436/166; 422/57; 422/82.05; 525/54.1

(57) ABSTRACT

A sensor element is formed from a sensing material immobilized by covalent bonding, such as nitrogen-carbon bonding, to a sol-gel glass or sol-gel copolymer to reduce leaching. A method of manufacturing such a sensor element involves covalently bonding the sensing material with the sol-gel precursor before hydrolysis of an organic silicate used in the process, or after the sol-gel matrix formation. Alternatively, the sol-gel can be surface treated to generate functional groups that facilitate the covalent bond formation.

### DESCRIPTION OF THE INVENTION

1. Field of the Invention

The present invention relates to chemical sensors as used in sensing material immobilized on sol-gels. More particularly, the invention relates to immobilizing sensing material to sol-gel glass or sol-gel copolymers using covalent bonds so that the sensing material does not leach or otherwise separate from the sol-gel.

2. Background of the Invention

Chemical sensors, in order to be reliable, reproducible and practical, usually require that whatever chemistry is incorporated in the sensor does not leach out into the surrounding matrix. Leaching can degrade the sensor's performance as well as contaminate the sample. Typically this problem has been addressed by creating a polymer support in which the sensing material of interest is covalently linked to the polymer and thereby incorporated into the sol-gel network. However, in the case of optically based sensors, the optical properties of the support are important.

Sol-gel glasses have been used as a basis for chemical sensors. Sol-gel glass is an optically transparent amorphous silica or silicate material produced by forming interconnections in a network of colloidal, sub-micron particles under increasing viscosity until the network becomes rigid, with about one-half the density of glass. Sol-gel copolymers are sol-gel polymers produced by the simultaneous polymerization of two or more dissimilar monomers using the same general process.

The process for sol-gel formation comprises forming glass at low temperatures from starting monomers or precursors by chemical polymerization in a liquid phase; a gel is formed from which glass can be derived by the successive elimination of the liquid phase such as water generated by condensation reactions. The sol-gel process uses hydrolysis and condensation of the starting monomers to produce a colloidal suspension (the “sol”), gelation (to form a porous network), and drying (and shrinking) to form the “gel.” Optionally, sintering at elevated temperatures makes the gel more dense to form a pore-free glass. Typically, the sol-gel process begins with soluble ingredients. Usually, these are organic silicates such as tetramethoxysilane (TMOS) or tetraethoxysilane (TEOS), which react with water and alcohol to form extremely small colloidal structures that comprise the sol. While mixing the liquid ingredients with the water and alcohol, a hydrolysis reaction occurs. The hydrated silica immediately interacts in a condensation reaction forming Si—O—Si bonds.

Linkage of additional Si—OH tetrahedra occurs as a polycondensation reaction, eventually resulting in a SiO₂ network. Hydrolysis and polycondensation reactions initiate at numerous sites within the TMOS or TEOS aqueous solution as mixing occurs. It is in this TMOS or TEOS aqueous solution that sol-gel precursors which form bonds with sensing material can be added. The term “sol-gel precursor” refers to any material added to the sol-gel solution for the purpose of binding with sensing material, including but not limited to organic silicates and functionalized silica alkoxides. The hydrolysis and polycondensation reactions also operate on these precursors. When sufficient interconnected Si—O—Si bonds are formed in a region they respond cooperatively as a colloidal (submicron) particle, or pre-network. The sol becomes the suspension of these colloidal particles in their parent liquid. The sol still behaves as a low-viscosity liquid and can be cast into a mold.

After casting into a mold, gelation occurs: the colloidal particles link together to become a three-dimensional network. When gelation occurs, viscosity increases sharply and a solid results. Aging of a gel involves keeping the gel immersed for some period of time (hours to days), during which time the gel decreases in porosity and develops the necessary strength.

The sol-gel glass is optically transparent but contains a large fraction of interconnected pores. Small analyte sensing compounds of various kinds can be incorporated into the porous matrix during the formation of the sol-gel. Because these compounds comprise small molecules, they tend to diffuse out of the glass, particularly at elevated temperatures. The properties of the sol-gel depend on the precursor used, the pH of the precursor solution, the water concentration and temperature.

The process of sol-gel formation has also been shown as a way to immobilize sensing material. A biosensor comprising a sensor element can contain sensing material by entrapping or caging such sensing material in the porous matrix during formation of the sol-gel. The sensing material remains active and relatively stationary, being physically trapped or entangled in the three-dimensional silica structure created during the sol-gel process. Sensing materials in general resist leaching with their size, but the problem arises when the physical dimensions of the sensing material are less than the pore size of the sol-gel. Such a leaching phenomenon is dominant when the entrapped sensing material is highly hydrophilic, like most pH sensors. Increasing the aging time to weeks or even months at room temperature or slightly elevated temperature helps reduce leaching to a certain extent, but such long aging is inefficient for device production, especially for multiple detection systems which involve other bio-organic molecules.

Leaching is a persistent problem in chemical sensors irrespective of the formation technique. Unless prevented, sensing material can (and generally does) leach off the matrix support. Covalent attachment of sensing material has been used to prevent the sensing material of interest from leaching, as well as to prevent the changes resulting from leaching, such as changes in the surface concentration and the contamination of surrounding liquid. The known method requires treatment of a surface to generate pendant functional groups that can then be reacted and bonded covalently with the sensing material. For example, aminopropyltriethoxysilane can be reacted with a silica surface to form amino-propyl silica. The pendant amino groups can be reacted with a carboxyl or other type of group on the sensing material to form a stable nitrogen-carbon bond. However, this adds an additional step in the process of making a sensor element after the sol-gel has been formed.

It is accordingly desirable to provide methods of covalently immobilizing sensing material on sol-gel glass or sol-gel copolymers and resulting sensor elements. Sensing material means any type of material, moiety, compound, polymer (whether monomer, precursor, copolymer) or enzyme used for its sensing properties such as sensitivity to pH, oxygen, ions, as well as other organic molecules. Sensing materials support a variety of analytical methods, including electrochemical, chemiluminescence, optical, electrical, and other methods. Blood chemistry tests such as blood gasses (including pO², pCO₂), blood pH, hematology, hematocrit and coagulation and hemoglobin factors, as well as immuno-diagnostics, and DNA testing, ions (Na⁺, Ca⁺⁺, K⁺), and small molecules such as glucose and lactate can be performed by sensing materials. Examples of pH sensitive polymers include poly(aklyl acrylate), poly(acryl meth acryl ate), poly(2-hydroxyethyl methacrylate) (HEMA), poly(2-hydroxypropylmethacrylate) (HPMA), poly(acrylamide), poly(N-vinyl pyrrolidone), poly(vinyl alcohol) (PVA), polyethylene oxide (PEO), poly(etherurethane), and polyelectrolyte.

This is achieved by immobilization based on covalent bonds, including but not limited to nitrogen-carbon bonds, oxygen-carbon bonds, and sulfur-carbon bonds. Such bonds can be formed with the sol-gel precursor before hydrolysis of the sol-gel precursor to form sol-gel glass, or during the sol-gel matrix formation. The methods to achieve such linkage require similar reactions whether the covalent bonds are formed between the sensing material and the sol-gel precursor before hydrolysis and condensation, or the covalent bonds are formed between the sensing material and the polymerizing sol-gel. The precursor, copolymer, or gelling matrix can be surface treated to generate functional groups that facilitate the covalent bond formation. For example, the surface treatment generates NHS ester groups to react with amino functionalized sensing materials, or amino functionalized groups to react with carboxyls on the sensing material thereby facilitating nitrogen-carbon bond formation. Alternatively, cross linking reagents can be used to connect the sensing material and the precursor or matrix. In another embodiment, the matrix can be reacted directly with a sensing material having an aggressive linking agent. The aggressive linking agent seeks out the uncondensed hydroxyl groups in the sol-gel polymer backbone and reacts with them. In one non-limiting embodiment, the aggressive linking agent includes but is not limited to chlorosilane.

### SUMMARY OF THE INVENTION

The invention comprises a sensor element in which a sensing material is immobilized by covalent bonding, such as nitrogen-carbon, oxygen-carbon, and sulfur-carbon bonding, to a sol-gel glass or sol-gel copolymer. Since the sensing material is covalently bonded to the sol-gel, leaching of such sensing material of interest into the surrounding medium is essentially eliminated.

The invention provides a sol-gel glass or sol-gel copolymer that is optically clear and that can be customized as to size and shape, and can be cast as a thin film. The sol-gel can be custom designed with monomers in order to determine the surface characteristics and linkage with the sensing material, such that the physical properties of the sensing material are not substantially affected.

The method of manufacturing a sensor element according to the invention provides that the sensing material covalently bonds with a precursor before hydrolysis of the sol-gel, or during matrix formation. Alternatively, the sol-gel can be surface treated to generate functional groups that facilitate the covalent bond formation, or the sensing material having an aggressive linking agent can react with the sol-gel glass directly. Multiple sensing materials can be combined on a biosensor to provide the desired detection mechanism which may require the sensing of several different analytes. This is achieved by treating two or more sensing materials separately on segregated sol-gel precursors and then mixing the precursors together prior to sol-gel formation, as in the case of sol-gel copolymer. Alternatively, a sensing material may be deliberately leached so that another sensing material may replace it at the leached sites.

It is to be understood that both the foregoing general description and the following detailed description are exemplary and explanatory only and are not restrictive of the invention, as claimed.

### DETAILED DESCRIPTION OF THE INVENTION

The invention provides a sensing material covalently bonded to a sol-gel glass (sol-gel copolymer) and a method for covalently bonding at least one such sensing material to form a sensor element. The method of covalently bonding the sensing material of the present invention provides a novel way to link currently commercially available sensing materials, including but not limited to those used for sensing oxygen and pH. The invention provides a sensing material which can be incorporated in a sensor element making it stable and giving it a lifetime of months or years at ambient conditions. The sensor element can be cast into any size, shape, or cast into a thin film. The sensing material will resist leaching out into the surrounding medium. The term “sensor element” refers to a component of a biosensor which provides an analyte sensing function involved in the biosensor detection mechanism.

A non-limiting embodiment of the present invention comprises reacting the sensing material with the sol-gel precursor. Sensing materials include any commercially available biosensing materials which may be covalently bonded to a sol-gel glass (sol-gel copolymer). An example of such a sensing material is 5-(- and-6)-carboxy SNARF® (Molecular Probes, Inc., Eugene, Oreg.). Other examples include Oregon Green 488 which may be used as a pH sensing material (Molecular Probes, Inc., Eugene, Oreg.); SNAFL® calcein which can be used as a pH sensing material (Molecular Probes, Inc., Eugene, Oreg.); carboxyfluorescein which can be used as a pH sensing material (Molecular Probes, Inc., Eugene, Oreg.); pH indicators-dextran conjugate which can be used as a pH sensor (Molecular Probes, Inc., Eugene, Oreg.) when at least one hydroxyl group has been activated with reagents such as disuccinimydyl carbonate prior to covalently bonding with a sol-gel precursor; quin-2 free acid which may be used as a calcium sensor (MolecularPprobes, Inc., Eugene, Oreg.); BTC tetrapotassium salt which may be used as a calcium sensing material (Molecular Probes, Inc., Eugene, Oreg.); fura-2 pentapotassium salt which may be used as a calcium sensing material (Molecular Probes, Inc., Eugene, Oreg.); Calcium Green™ hexapotassium salt (Molecular Probes, Inc., Eugene, Oreg.) which may be used as a calcium sensing material; Calcium Crimson™ tetrapotassium salt (Molecular Probes, Inc., Eugene, Oreg.)which may be used as a calcium sensing material; mag-fura-2 tetrapotassium salt (Molecular Probes, Inc., Eugene, Oreg.) which may be used as a magnesium sensing material; mag-fura-5 tetrapotassium salt (Molecular Probes, Inc., Eugene, Oreg.) which may be used as a magnesium sensing material; APTRA-BTC tripotassium salt (Molecular Probes, Inc., Eugene, Oreg.) which may be used as a zinc sensing material.

Such sensing materials can be covalently bonded to with a sol-gel precursor in a synthesis such as the following using 5-(-and-6)-carboxy SNARF®:

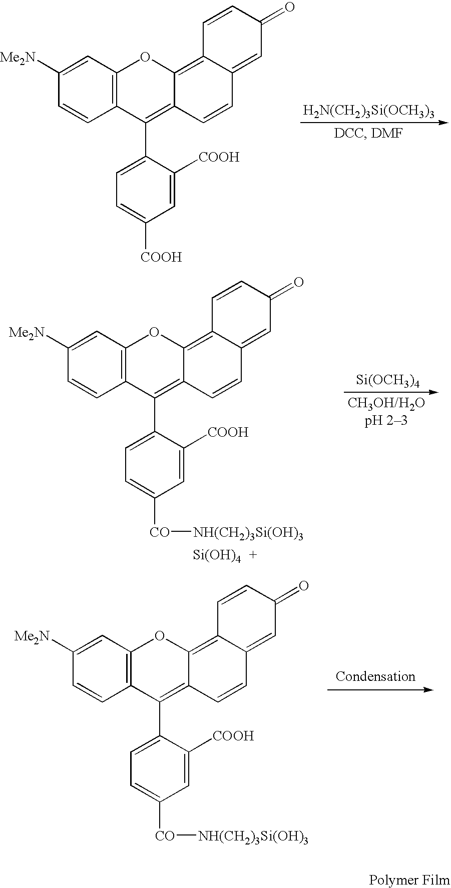

An excess amount of 3-aminopropyltrimethoxy silane (Fluka Chemie AG, Buchs, Switzerland) is reacted with 5-(-and-6)-carboxy SNARF® in an excess amount of N,N′-Dicyclohexylcarbodiimide, commercially available as DCC® (Aldrich), and N-hydroxylsuccinimide (“NHS ester”), with anhydrous N,N-Dimethylformamide (“DMF”) as solvent. Other analyte sensing compounds with either amino functional groups or carboxyl functional groups may be linked in such a manner by using cross linking reagents such as esters having the formula NHS—R—NHS where R represents a C₁ to about C₁₀ alkyl or C₆ to about C₂₀ aryl (for example di-NHS ester), S═C═N—R—N═C═S where R represents alkyl or aryl (for example di-isothiocyanate), OHC—R—CHO where R represents a C₁ to about C₁₀ alkyl or C₆ to about C₂₀ aryl (for example glutaric dialdehyde), or a mixed type of cross-linker such as maleimide-R—CHO where R represents a C₁ to about C₁₀ alkyl or C₆ to about C₂₀ aryl to link the amino functional group on the sensing material to the amino group on the sol-gel precursor, (for example 3-aminopropyltrimethoxy silane).

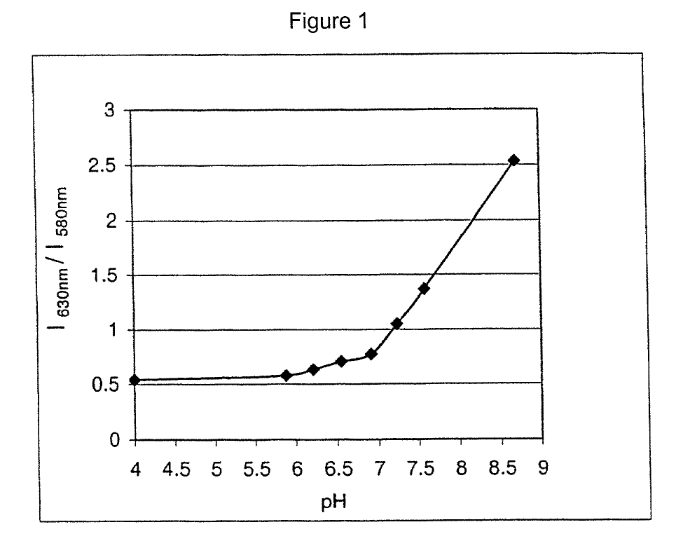

The covalently bonded sensing material and sol-gel precursor complex is hydrolyzed with methoxy silane in the presence of methanol and water at a pH of about 2 to about 3 to form the sol-gel and condensed to form a polymer film. The gel is then aged for a relatively short period of time (e.g. one day). FIG. 1 illustrates the pH response of SNARF as a sensor element. The graph in FIG. 1 shows a linear relationship between the ratio of emission (630 nm for basic form and 580 nm for acidic form) and pH in the physiological range. Such a linear relationship allows the sensor element to be incorporated into a biosensor for detecting pH of biological fluid for diagnostic purposes.

Another example of a sensing material is a ruthenium complex. Ruthenium complexes generate profound interest in the field of sensing due to their long lifetimes. They are used in oxygen sensing and pH sensing (through paring with pH sensitive acceptors for example). A large number of substituents for ruthenium complexes provide even better flexibility to use the methods of the present invention for covalent immobilization on sol-gel surfaces. Examples of commercially available ruthenium sensors include Ru-Bis-(2,2′-bipyridine)(4,4′-disuccinimidylcarbonyl-2,2′-bipyridine) which may be used as an oxygen sensing material or a pH sensing material when paired with a pH sensitive acceptor (Fluka Chemie AG, Buchs, Switzerland); Ru-Bis-(2,2′-bipyridine)(5-isothiocyanatophenanthroline) (Fluka Chemie AG, Buchs, Switzerland)which may be used as an oxygen sensing material or a pH sensing material when paired with a pH sensitive acceptor; and Bromothymol Blue, Bromocresol Green and Naphthol Blue Black (Aldrich) which may be used as pH indicators or used as ruthenium complex acceptors for fluorescence resonance energy transfer (FRET) measurements when at least one of their sulfonic acid groups has to be activated by PCl₅ before reacting with an amino-functionalized sol-gel precursor.

Ruthenium complexed sensing materials may be covalently bonded to sol-gel precursors in a synthesis such as the following:

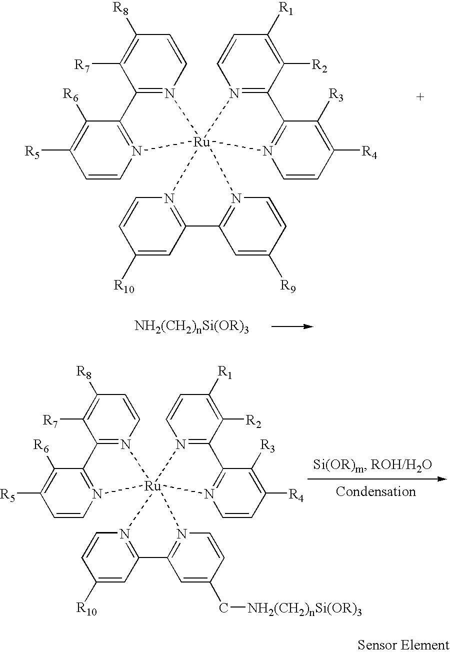

R₁ through R₈ represent either hydrogen, C₁ to about C₁₀ alkyl or C₆ to about C₂₀ aryl leading to the formation of substituted or nonsubstituted phenanthroline. R₉ and R₁₀ represent at least one reactive functional group directly or indirectly linked to bipyridine/phenanthroline structure that may react readily with amino, thiol, hydroxyl, or other functional groups on the sol-gel precursor or sol-gel glass or sol-gel copolymer. The variable n represents integers 0 through about 20, and the variable m represents integers 0 through about 4. R represents any alkyl having 1 to about 10 carbon atoms. In the synthesis, the ruthenium complex is reacted with functionalized silica alkoxide to form covalent linkage, hydrolyzed with alkoxy silane having 1 to about 10 carbon atoms in the presence of C₁ to about C₆ alcohol and water at acidic or basic pH, and then condensed into the sensor element by this series of reactions.

In an alternate method, the covalent linkage between the sensing material and the sol-gel occurs after the sol-gel glass or sol-gel copolymer formation. This linkage can be formed in a similar synthesis as the one for linking the sensing material to the sol-gel precursor. Such a synthesis may consist of:

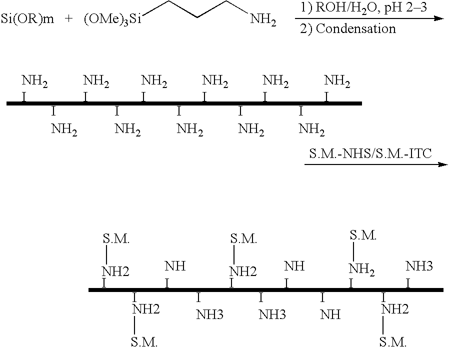

The symbol “S.M.” in the synthesis above refers to the sensing material. R represents any alkyl having from 1 to about 10 carbon atoms. The variable m represents integers 0 through 4. The sol-gel is hydrolyzed at a pH of about 2 to about 3 and then condensed. The sol-gel has an amino modified polymer surface. This is reacted with the sensing material functionalized with NHS groups or isothiocyanate (ITC) groups. This step also applied to sensing material with cross linking reagents as discussed previously for covalent bridging with the sol-gel precursor.

In a non-limiting alternate method, the sol-gel surface is modified to facilitate covalent linkage between the analyte sensing compound and the sol-gel. A sol-gel glass or sol-gel copolymer with surface C₁ to about C₁₀ alkyl groups or C₆ to about C₂₀ aryl groups can be oxidized to carboxyl groups as is well known in the art. The carboxyl groups can be converted to NHS esters by reaction with NHS in the presence of DCC. The NHS ester groups on the surface of the sol-gel can be reacted with amino functionalized sensing material to result in a covalent nitrogen-carbon bond between the sol-gel and the analyte sensing compound. Alternatively, the NHS ester groups on the surface of the sol-gel can be reacted with a C₁ to about C₁₀ alkyl diamine or C₆ to about C₂₀ aryl diamine and then reacted with analyte sensing compound functionalized with NHS groups or ITC groups to result in a covalent nitrogen-carbon bond between the sol-gel and the sensing material. This is similar to the reaction of sensing material with the sol-gel after matrix formation discussed previously. Alternatively, an amino group may be transformed to maleimide and reacted with sensing material having a thiol group to form a covalent sulfur-carbon bond. An illustrative synthesis of the nitrogen-carbon covalent bond may consist the following reactions:

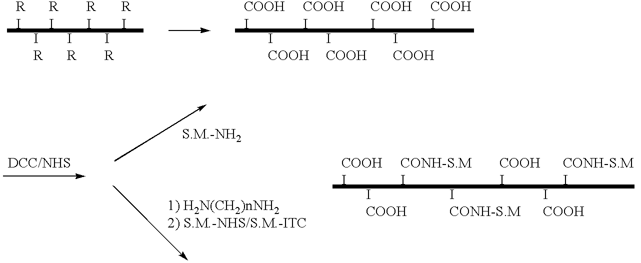

The symbol “S.M.” in the synthesis above refers to a sensing material. R represents a C₁ to about C₁₀ alkyl or C₆ to about C₂₀ aryl groups on the surface of the sol-gel which are oxidized to carboxyl groups. The variable n represents 1 to about 20.

In a non-limiting alternate method, the sol-gel may be reacted directly with a sensing material using an aggressive linking agent. An aggressive linking agent, including but not limited to chlorosilane, seeks out uncondensed hydroxyl groups in the sol-gel polymer backbone and reacts with them. The sol-gel glass typically does not become 100% condensed and maintains reactive hydroxyl groups on the surface. An aggressive linking agent such as chlorosilane seeks out such groups and links to them in a super dry environment. Chlorosilane is first linked to a sensing material, such as a ruthenium complex prior to reaction with the sol-gel glass. An illustrative synthesis may consist the following reactions:

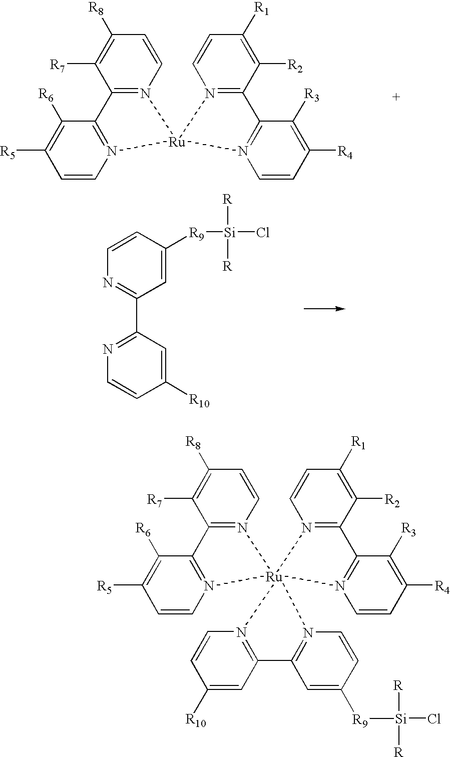

R₁ through R₈ represent either hydrogen,C₁ to about C₁₀ alkyl or C₆ to about C₂₀ aryl groups as defined before. The aryl groups may lead to the formation of nonsubstituted or substituted phenanthroline. R₉ and R₁₀ represent C₁ to about C₁₀ alkyl or C₆ to about C₂₀ aryl groups at least one of which is linked to chlorosilane. R represents hydrogen, a C₁ to about C₁₀ alkyl, C₆ to about C₂₀ aryl, or any halide. The chlorosilane when complexed with the ruthenium remains aggressive and reacts readily with Si—OH on the sol-gel surface to form Si—O—Si bonds. Other aggressive linking agents can comprise alkoxysilanes, alkyl-trichlorosilanes, and other related materials known in the art.

### EXAMPLE 1

This example illustrates the reaction of 5-(-and-6)-carboxy SNARF® (“SNARF”)with sol-gel precursor. Half a milligram of SNARF was dissolved in 60 micro liters of anhydrous DMF. The resulting solution had a very light brownish color, to which 1.1 milligram of DCC (10 times excess) was added. The mixture was stirred at room temperature for 2 hours. Then 9.6 micro liters of 3-aminopropyltrimethoxy silane (50 times excess) was added. The solution was stirred at room temperature under dark for six hours. The resulting solution turned blue in the presence of the 3-aminopropyltrimethoxy silane.

The sol mixture was prepared by combining 0.75 milliliters of TMOS, 0.3 milliliters of water, one milliliter of methanol, 0.030 milliliters of surfactant solution (0.02 M SDS in methanol), and 0.1 milliliter of 1N HCl. The SNARF solution was added to the freshly prepared sol. The resulting mixture turned reddish-purple immediately. The mixture was kept at room temperature, in the dark, at a pH between two and three over night. The resulting sol solution was used to spin-coat plasma treat polycarbonate at 1100 rpm. The absorbance of the resulting sensor element was tested at varying levels of pH in the biological range. FIG. 1 illustrates the plot of those results.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. A method of making a sensor element comprising:
reacting at least one sensing material with at least one sol-gel precursor to form at least one covalent bond between said sensing material and said sol-gel precursor to form a sensing material/sol-gel precursor compound; and
forming a sol-gel from said sensing material/sol-gel precursor compound.

2. A method of making a sensor element according to claim 1 wherein:
said sol-gel precursor comprises an organic silicate.

3. A method of making a sensor element according to claim 2 wherein:
said organic silicate includes a functionality which comprises an amino functionality.

4. A method of making a sensor element according to claim 1 wherein:
said covalent bond comprises at least one bond chosen from nitrogen-carbon, oxygen-carbon, and sulfur-carbon.

5. A sensor element comprising:
least one sol-gel species chosen from sol-gel precursor, sol-gel glass, and sol-gel copolymer; and
a sensing material covalently bonded to said sol-gel species,
whereby said sensor element is formed by reacting said sensing material with at least one sol-gel precursor.

6. A method of making a sensor element comprising:
reacting at least one sensing material with at least one cross linking reagent to form a sensing material/cross linking reagent compound; and
reacting said sensing material/cross linking reagent compound with at least one sol-gel species chosen from a sol-gel precursor, sol-gel glass, and sol-gel copolymer, to form at least one covalent bond between said sensing material and said sol-gel species.

7. A method of making a sensor element according to claim 6, further comprising:
forming a sol-gel from said second compound comprising at least one sol-gel precursor.

8. A method of making a sensor element according to claim 6 wherein:
said cross linking reagent comprises at least one component chosen from esters having the formula NHS—R—NHS where R represents a C₁ to about C₁₀ alkyl or C₆ to about C₂₀ aryl, S═C═N—R—N═C═S where R represents a C₁ to about C₁₀ alkyl or C₆ to about C₂₀ aryl, OHC—R—CHO where R represents a C₁ to about C₁₀ alkyl or C₆ to about C₂₀ aryl, and maleimide-R—CHO where R represents a C₁ to about C₁₀ alkyl or C₆ to about C₂₀ aryl.

9. A method of making a sensor element according to claim 8 wherein:
said cross linking reagent comprises at least one component chosen from di-NHS ester, di-isothiocyanate, and glutaric dialdehyde.

10. A method of making a sensor element according to claim 6 wherein:
said covalent bond comprises at least one bond chosen from nitrogen-carbon, oxygen-carbon, and sulfur-carbon.

11. A sensor element comprising:
a sol-gel comprising at least one sol-gel species chosen from sol-gel precursor, sol-gel glass, and sol-gel copolymer; and
a sensing material covalently bonded to said sol-gel species,
whereby said sensor element is formed by reacting said sensing material with at least one cross linking reagent.

12. A method of making a sensor element comprising:
treating at least one sol-gel species chosen from sol-gel precursor, sol-gel glass, and sol-gel copolymer to form at least one functional group; and
reacting at least one sensing material with said species to form at least one covalent bond between said sensing material and said sol-gel species.

13. A method of making a sensor element according to claim 12 further comprising:
forming a sol-gel from said sol-gel species.

14. A method of making a sensor element according to claim 12 wherein:
said sol-gel species has at least one alkyl group or aryl group forming said functional group by oxidizing said at least one alkyl group or aryl group on said sol-gel species to at least one functional carboxyl group.

15. A method of making a sensor element according to claim 14 further comprising:
reacting said carboxyl group to form at least one amino group or thiol group.

16. A sensor element comprising:
a sol-gel; and
a sensing material covalently bonded to said sol-gel,
whereby said sensor element is formed by treating a sol-gel precursor to form at least one functional group, wherein said functional group is covalently bonded.

17. A method of making a sensor element comprising:
reacting at least one sensing material with at least one aggressive linking reagent; and
reacting said aggressive linking reagent with at least one sol-gel species chosen from sol-gel glass, and sol-gel copolymer, to form at least one covalent bond between said aggressive linking reagent and said sol-gel species.

18. A method of making a sensor element according to claim 17 wherein:
said aggressive linking agent comprises chlorosilane.

19. A sensor element comprising:
a sol-gel comprising at least one sol-gel species chosen from sol-gel precursor, sol-gel glass, and sol-gel copolymer; and
a sensing material, wherein said sensing material is covalently bonded to said sol-gel species by an aggressive linking agent.

20. A method of making a sensor element according to claims 1, wherein:
said sensing material is SNARF or a ruthenium complex.
